(19) United States
(12) Patent Application Publication
(10) Pub. No.: US 2007/0076065 A1
(43) Pub. Date: Apr. 5, 2007

(54) Ink tank with an air prevention component

(75) Inventors: Michael Clark Campbell, Lexington, KY (US); Trevor Daniel Gray, Midway, KY (US); Bhaskar Ramakrishnan, Lexington, KY (US)

Correspondence Address: LEXMARK INTERNATIONAL, INC.;INTELLECTUAL PROPERTY LAW DEPARTMENT, 740 WEST NEW CIRCLE ROAD, BLDG. 082-1, LEXINGTON, KY, 40550-0999, US

(73) Assignee: Lexmark International, Inc.

(21) Appl. No.: 11/241,217

(22) Filed: Sep. 30, 2005

(51) Int. Cl. B41J 2/175

(52) U.S. Cl. 347/86

(57) ABSTRACT

Ink tanks and recording devices incorporating the ink tanks comprise a free ink chamber, and a negative pressure generating chamber in the ink tank. The negative pressure generating chamber comprises a floor member comprising at least one projection extending along at least a portion of the floor member, and a porous material, wherein the projection of the floor member is configured to engage the porous material to inhibit the creation of an air flow path between the porous material and the floor member. The ink tank further comprises a partition wall disposed between the free ink chamber and the negative pressure generating chamber and configured to allow the flow of ink from the free ink chamber to the negative pressure generating chamber.

### FIELD OF THE INVENTION

This invention is generally directed to ink tanks and devices incorporating ink tanks, and is specifically directed to ink tanks with components configured to prevent air flow from the bottom of the ink tank.

### BACKGROUND OF THE INVENTION

Recording devices, such as printers, copiers, and the like, incorporating single of multi-chamber ink tanks are well known in the art. As shown in FIG. 3, multi-chamber ink tanks 1 that are known in the art generally include a negative pressure generating chamber and a free ink chamber separated by a partitioning wall. The partitioning wall communicates between the two chambers and controls air flow from the top of the tank into the free ink chamber, and the air flow facilitates the release of ink from the free ink chamber. In any tank system, controlling the flow of air in the ink tank impacts ink tank efficiency and reliability. Accordingly, as demand increases for improved capacity in printers, copiers and the like, the need arises for improvements in components thereof, for example, ink tanks that maximize ink capacity by controlling air flow in the ink tank.

### SUMMARY OF THE INVENTION

According to a first embodiment of the present invention, an ink tank is provided. The ink tank comprises a free ink chamber, and a negative pressure generating chamber comprising a floor member comprising at least one projection extending along at least a portion of the floor member, and a porous material, wherein the projection of the floor member is configured to engage the porous material to minimize the creation of an undesirable air flow path between the porous material and the floor member. The ink tank further comprises a partition wall disposed between the free ink chamber and the negative pressure generating chamber and configured to allow the flow of ink from the free ink chamber to the negative pressure generating chamber.

According to a second embodiment of the present invention, a recording device comprising an ink tank, and a print head configured to be coupled to the ink tank is provided. The ink tank comprises a free ink chamber, and a negative pressure generating chamber comprising a floor member comprising at least one projection extending along at least a portion of the floor member, and a porous material, wherein the projection of the floor member is configured to engage the porous material to minimize the creation of an undesirable air flow path between the porous material and the floor member. The ink tank further comprises a partition wall disposed between the free ink chamber and the negative pressure generating chamber and configured to allow the flow of ink from the free ink chamber to the negative pressure generating chamber.

The ink tanks of the present invention provide improvements and advantages in ink tank reliability and efficiency, for example, by maximizing the amount of ink used in the ink tank. These and additional features and advantages provided by the ink tanks of the present invention will be more fully understood in view of the following detailed description.

### BRIEF DESCRIPTION OF THE DRAWINGS

While the specification concludes with claims particularly pointing out and distinctly claiming the present invention, it is believed the same will be better understood from the following description taken in conjunction with the accompanying drawings in which:

FIG. 1 is a schematic view of an ink tank according to an embodiment of the present invention; and

FIG. 2 is another schematic view of an ink tank illustrating an insertion of a wick into the ink tank according to an embodiment of the present invention.

FIG. 3 is a schematic view of a prior art multi-chamber ink tank.

The embodiments set forth in the drawings are illustrative in nature and not intended to be limiting of the invention defined by the claims. Moreover, individual features of the drawings and the invention will be more fully apparent and understood in view of the detailed description.

### DETAILED DESCRIPTION

Reference will now be made in detail to various embodiments, which are illustrated in the accompanying drawings, wherein like numerals indicate similar elements throughout the views.

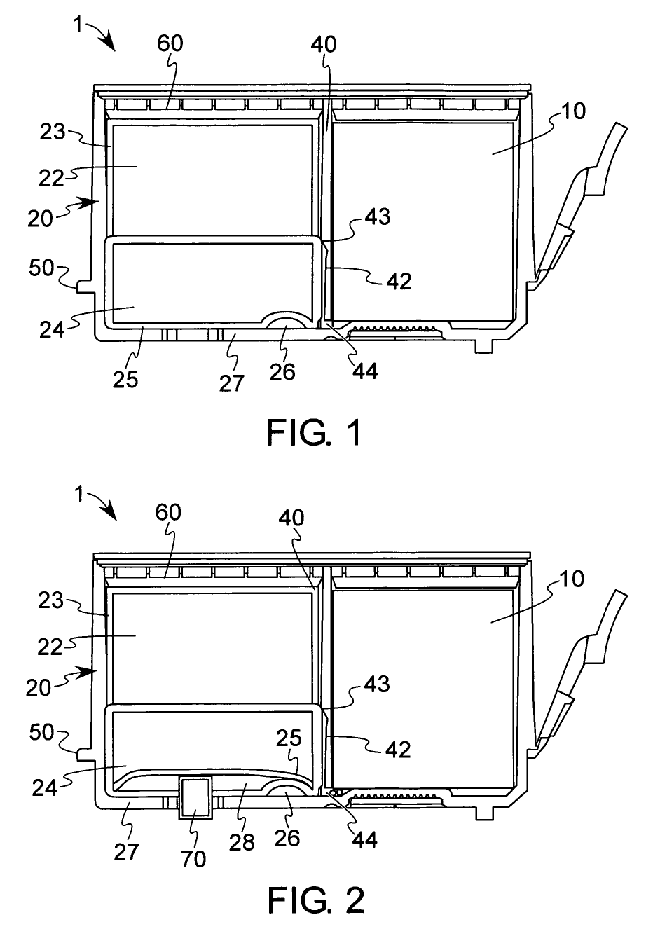

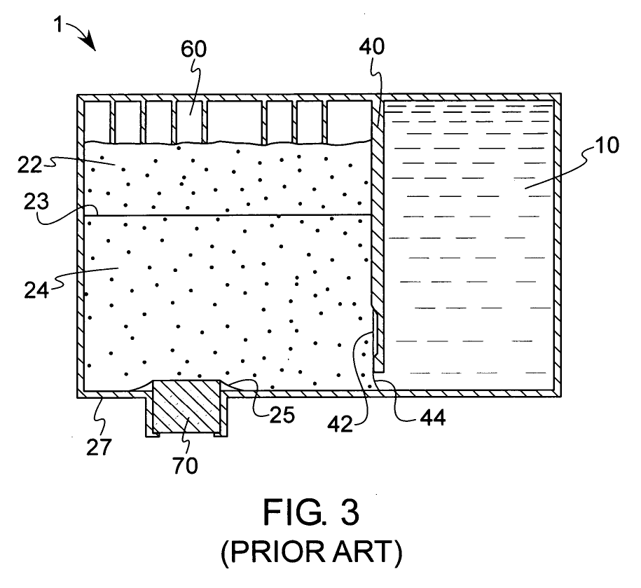

The present invention is directed to an ink tank 1 with components configured to prevent the flow of air from the bottom of the ink tank. Referring to FIGS. 1 and 2, an ink tank 1 includes two chambers, generally arranged side-by-side. The ink tank 1 has a free ink chamber 10, which is configured to store and dispense ink. Essentially, the free ink chamber 10 constitutes an ink reservoir for the ink tank 1.

The ink tank 1 further includes a negative pressure generating chamber 20. The negative pressure generating chamber 20 has a floor member 27 and a porous material 25. The floor member 27 has at least one projection 26 that extends along at least a portion of the floor member 27 and is configured to engage the porous material 25 to minimize the creation of an undesirable air flow path between the porous material 25 and the floor member 27.

The ink tank further includes a partition wall 40 disposed between the free ink chamber 10 and the negative pressure generating chamber 20. The partition wall 40 is configured to allow the flow of ink 10 from the free ink chamber to the negative pressure generating chamber 20. In another embodiment, the partition wall 40 may include a projection (not shown) configured to minimize the creation of an undesirable air flow path in the negative pressure generating chamber 20. In further embodiment, the partition wall 40 may include a recessed groove 42 etched into at least a portion of the partition wall 40, and an opening 44 below the recessed groove 42 configured to allow a flow of ink out of the free ink chamber 10 and a flow of air into the free ink chamber 10. The recessed groove 42 may be of any suitable geometry known to one of ordinary skill in the art.

The ink tank 1 may optionally include an air vent 60 oriented above the negative pressure generating chamber 20. The vent 60 may comprise any suitable configuration known to one skilled in the art; however, the vent 60 typically defines a serpentine configuration. In one embodiment, the free ink chamber 10 is not vented and the opening 44 constitutes the only communication port with the negative pressure generating chamber 20. In a further embodiment of the present invention, the partition wall 40 may be configured to allow an air flow path extending from the vent 60 into the free ink chamber 10. The air flow path flows through a spacing created between the top 43 of the recessed groove 42 and the compressed porous material 25.

The negative pressure generating chamber 20 may have multiple sections. In one embodiment, the negative pressure generating chamber 20 has a top ink draining section 22, which includes porous material 23 and is configured to dispense ink, and a bottom ink drain section 24 disposed between the floor member 27 and the top ink draining section 22. Like the top ink draining section 22, the bottom ink draining section 24 also has porous material 25 and is configured to dispense ink. Typically, the bottom ink draining section 24 dispenses ink after the ink from the top ink draining section 22 has been drained. Additionally, the bottom ink draining section 24 may include porous material 25 more compressed than the porous material 23 of the top ink draining section 22. The porous materials of the top ink draining section 22 and the bottom ink draining section 24 may both be compressed; however, the porous material 25 of the bottom ink draining section 24 may be more compressed, because the bottom ink draining section 24 is generally maintained under higher pressure than the top ink draining section 22.

The compressed porous material 25 of the bottom ink draining section 24 engages the floor member projection 26 to minimize the creation of air flow paths between the floor member 27 and the porous material 25. Furthermore, the compressed porous material 25 is configured to continuously engage the floor member projection 26. Through compression, the porous material 25 may maintain continuous contact with the floor projection 26, even if the porous material 25 is separated from the floor member 27, as shown in FIG. 2. In the illustrated embodiment, the projection 26 has a curved shape, but one of ordinary skill in the art will readily recognize that the projection 26 can have a sharp point or take any other shape so long as the projection maintains. contact with the porous material 25 and prevents, or at least inhibits, air flow along the floor.

The negative pressure generating chamber 20 releases the ink through the pores of its porous material. The top ink draining section 22 may have a porous material 23 with a larger pore size than the pores of the compressed material 25 of the bottom ink draining section 24. The ink is released via the application of pressure and/or heat to the negative pressure generating chamber 20. In one embodiment, the ink is first drained from the top ink draining section 22, wherein the draining results in a buildup of capillary pressure in the negative pressure generating chamber 20. After the ink is drained from the top ink draining section 22, the bottom ink draining section 24 begins to dispense ink, optionally due to the application of capillary pressure, which was generated during the draining of the top ink draining section 22. The bottom ink draining section 24 releases an amount of ink sufficient to generate an air flow path in the above-described spacing between the top 43 of the recessed groove 42 and the compressed porous material 25. The free ink chamber 10 may then to dispense ink to the negative pressure generating chamber 20 upon receiving air via the air flowpath. In essence, the free ink chamber 10 dispenses the ink and air fills the void in the chamber 10. Subsequently, the ink from the free ink chamber 10 is delivered to the negative pressure generating chamber 20, typically into the bottom ink draining section 24, wherein the ink may then be delivered to an ink supply port 50 that is located adjacent the negative pressure generating chamber 20 and is configured to receive ink from the negative pressure generating chamber 20. The recessed groove 42 is operable to control the flow of ink into the negative pressure generating chamber 20 from the free ink chamber 10. For example, if too much ink is provided to the bottom ink draining section 24, the spacing between the top 43 of the groove 42 and the compressed porous material 25 will be eliminated. Consequently, the flow of air into the free ink chamber 10 and thereby the flow of ink out of the free ink chamber 10 will be interrupted.

The ink tank 1, for example, on its outer surface, may be constructed with any materials known to one skilled in the art. Exemplary materials include but are not limited to polymers, plastics, ceramics, metal, fabric, wood and the like. In one exemplary embodiment, the ink tank 1 is molded from a polymeric material selected from the group consisting of glass-filled polybutylene terephthalate available from G.E. Plastics of Huntersville, N.C. under the trade name VALOX 855, amorphous thermoplastic polyetherimide available from G.E. Plastics under the trade name ULTEM 1010, glass-filled thermoplastic polyethylene terephthalate resin available from Dow Chemical Company of Midland, Mich., under the trade name QUESTRA, polyphenylene ether/polystyrene alloy resin available from G.E. Plastics under the trade name NORYL SEI and NORYL 300X and polyamide/poly-phenylene ether alloy resin available from G.E. Plastics under the trade name NORYL GTX. The floor member 27, and the floor member projection 26, which is generally molded into the floor member 27, also comprises the above listed materials.

The porous material 23 of the top ink draining section 22 and/or the porous material 25 of the bottom ink draining section 24 may comprise ink absorbing felt. In a specific embodiment, the ink absorbing felt comprises polyurethane foam, polyethylene, polypropylene, polyester, and combinations thereof. The ink absorbing felt is configured to prevent leaking of ink through the top 22 and bottom 24 ink draining sections, unless some pressure and/or heat is applied to sections 22 and 24. When pressure and/or heat is applied, the top 22 and/or bottom 24 ink draining sections are configured to dispense ink through their pores.

The floor member projection 26 may have any geometry with sufficient surface area for engaging the compressed porous material 25 to minimize, or at least inhibit, air flow paths created between the porous material 25 and the floor member 27. In one embodiment as shown in FIGS. 1 and 2, the floor member projection 26 defines a concave shaped configuration. If these air flowpaths are unabated, it may negatively impact the efficiency of the ink tank 1. Specifically, this detrimental air path could cause the free ink chamber 10 to drain prior to the draining of the top ink draining section 22 and/or the bottom ink draining section 24, thus limiting the yield of the ink tank 1. This detrimental air path may be caused by an improper porous material, for example, ink absorbing felt, or improper sizing of the felt in the negative pressure reducing chamber. In a further embodiment

In a further embodiment of the present invention, a recording device, such as a printer or copier, comprising the ink tank 1 described above and a printhead configured to be coupled to the ink tank is provided. In one embodiment as shown in FIG. 2, the ink tank may be coupled to the print head by inserting a wick 70 into the bottom ink draining section 24. As stated in the Background, the insertion of the wick 70 may separate the porous material 25 and the floor member 27, thus generating a detrimental air flowpath. In accordance with the present invention, the continuous engagement between the floor member projection 26 and the compressed porous material 25 is operable to combat these detrimental air paths. The floor member projection 26 engages the compressed porous material 25 to block air flow in region 28 between the separated compressed material 25 and the floor member 27. As shown in FIG. 2, the compressed porous material 25 maintains contact with the floor member projection 26, even when other portions of the porous material 25 are separated from the floor member 27. This continuous contact acts as a valve shutting down the flow of air in region 28, thus eliminating the detrimental air paths described above.

It is noted that terms like “specifically,” “generally” “optionally”, “preferably,” “typically”, “often”, and the like are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention. It is also noted that terms like “substantially” and “about” are utilized herein to represent the inherent degree of uncertainty that may be attributed to any quantitative comparison, value, measurement, or other representation.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. An ink tank comprising:
a free ink chamber;
a negative pressure generating chamber comprising a floor member comprising at least one projection extending along at least a portion of the floor member, and a porous material, wherein the projection of the floor member is configured to engage the porous material to inhibit the creation of an air flow path between the porous material and the floor member; and
a partition wall disposed between the free ink chamber and the negative pressure generating chamber and configured to allow the flow of ink from the free ink chamber to the negative pressure generating chamber.

2. An ink tank according to claim 1 wherein the floor member comprises a projection configured to minimize the creation of an air flow path in the negative pressure generating member.

3. An ink tank according-to claim 1 wherein the partition wall comprises a recessed groove etched into at least a portion of the partition wall.

4. An ink tank according to claim 3 wherein the partition wall comprises an opening below the recessed groove.

5. An ink tank according to claim 4 wherein the recessed groove defines a bubble shaped geometry.

6. An ink tank according to claim 1 further comprising an air vent oriented above the negative pressure generating chamber.

7. An ink tank according to claim 1 wherein the air vent defines a serpentine configuration.

8. An ink tank according to claim 1 wherein the negative pressure generating chamber comprises:
a top ink draining section comprising porous material and being configured to dispense ink, and
a bottom ink draining section disposed between the floor member and the top ink draining section comprising porous material, and being configured to dispense ink after the ink from the top ink draining section has been dispensed.

9. An ink tank according to claim 8 wherein the porous material of the bottom ink draining section is more compressed than the porous material of the top ink draining section

10. An ink tank according to claim 1 wherein the porous material of the negative pressure generating member comprises ink absorbing felt.

11. An ink tank according to claim 10 wherein the ink absorbing felt comprises polyethylene, polypropylene, and combinations thereof.

12. An ink tank according to claim 1 wherein the porous material of the negative pressure generating member is configured to dispense ink through its pores.

13. An ink tank according to claim 1 wherein the floor member projection defines a concave shaped configuration.

14. An ink tank according to claim 1 wherein the at least one projection comprises multiple projections arranged in series along at least a portion of the floor member.

15. An ink tank according to claim 1 further comprising an ink supply port located adjacent the negative pressure generating chamber and configured to receive ink from the negative pressure generating chamber.

16. A recording device comprising:
an ink tank comprising;
a free ink chamber,
a negative pressure generating chamber comprising a floor member comprising at least one projection extending along at least a portion of the floor member, and a porous material, wherein the projection of the floor member is configured to engage the porous material to inhibit the creation of an air flow path between the porous material and the floor member; and
a partition wall disposed between the free ink chamber and the negative pressure generating chamber configured to allow the flow of ink from the free ink chamber to the negative pressure generating chamber;
and
a printhead configured to couple to the ink tank.
